(19) United States
(12) Patent Application Publication
(10) Pub. No.: US 2020/0210486 A1
(43) Pub. Date: Jul. 2, 2020

(54) PROBLEM AMPLIFICATION AND NOTIFICATION

(71) Applicant: International Business Machines Corporation, Armonk, NY (US)

(72) Inventors: Vijay Ekambaram, Chennai (IN); Nitin Gupta, Saharanpur (IN); Ruhi Sharma Mittal, Bangalore (IN); Sarbajit K. Rakshit, Kolkata (IN)

(21) Appl. No.: 16/238,412

(22) Filed: Jan. 2, 2019

(51) Int. Cl. G06F 16/903; G08B 7/06

(52) U.S. Cl. CPC G06F 16/90335; G08B 7/06

(57) ABSTRACT

One embodiment provides a method, including: receiving information from at least one sensor, wherein the information indicates an issue within an environment, wherein the issue has a first severity; identifying, using the information, at least one possible problem that (i) has a greater severity than the first severity and (ii) can occur if the issue is not resolved; the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and providing, to a user, a notification, wherein the notification illustrates the at least one possible problem.

### BACKGROUND

Environments (e.g., homes, workplaces, retail locations, etc.) of people have many different components, for example, plumbing, appliances, electricity, other people, and so on. Some of these components may have parts that can deteriorate or completely fail. Thus, people frequently encounter issues within their environment. For example, a person may find small puddles of water within a laundry room of a house. As another example, a person may smell an odor from a trashcan in a kitchen of an office space. Many times these problems are minor problems that do not result in severe damage to the environment if addressed relatively quickly.

### BRIEF SUMMARY

In summary, one aspect of the invention provides a method, comprising: receiving information from at least one sensor, wherein the information indicates an issue within an environment, wherein the issue has a first severity; identifying, using the information, at least one possible problem that (i) has a greater severity than the first severity and (ii) can occur if the issue is not resolved; the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and providing, to a user, a notification, wherein the notification illustrates the at least one possible problem.

Another aspect of the invention provides an apparatus, comprising: at least one processor; and a computer readable storage medium having computer readable program code embodied therewith and executable by the at least one processor, the computer readable program code comprising: computer readable program code configured to receive information from at least one sensor, wherein the information indicates an issue within an environment, wherein the issue has a first severity; computer readable program code configured to identify, using the information, at least one possible problem that (i) has a greater severity than the first severity and (ii) can occur if the issue is not resolved, wherein the identifying comprises accesses a secondary source to identify the at least one possible problem; the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and computer readable program code configured to provide, to a user, a notification, wherein the notification illustrates the at least one possible problem.

An additional aspect of the invention provides a computer program product, comprising: a computer readable storage medium having computer readable program code embodied therewith, the computer readable program code executable by a processor and comprising: computer readable program code configured to receive information from at least one sensor, wherein the information indicates an issue within an environment, wherein the issue has a first severity; computer readable program code configured to identify, using the information, at least one possible problem that (i) has a greater severity than the first severity and (ii) can occur if the issue is not resolved, wherein the identifying comprises accesses a secondary source to identify the at least one possible problem; the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and computer readable program code configured to provide, to a user, a notification, wherein the notification illustrates the at least one possible problem.

A further aspect of the invention provides a method, comprising: receiving information from at least one sensor that indicates a problem within an environment of a user, wherein the problem comprises a problem having a first issue level; identifying a possible problem if the problem is not addressed, wherein the possible problem comprises an amplified version of the problem having a higher issue level than the first issue level; the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and providing, responsive to detecting the user is in proximity to the amplified problem, a notification to the user, wherein the notification comprises (i) a visual notification generated from the at least one image and (ii) a non-visual notification

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of generating and providing a notification illustrating a larger problem resulting from a smaller issue detected with one or more sensors.

FIG. 2 illustrates an example a system for generating and providing a notification illustrating a larger problem resulting from a smaller issue detected with one or more sensors.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

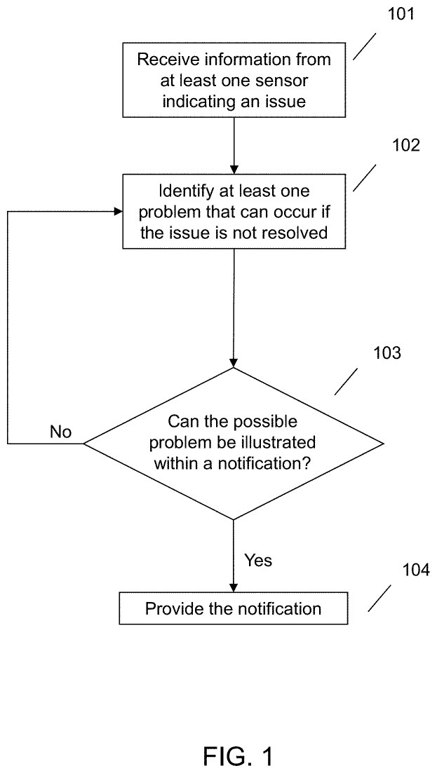

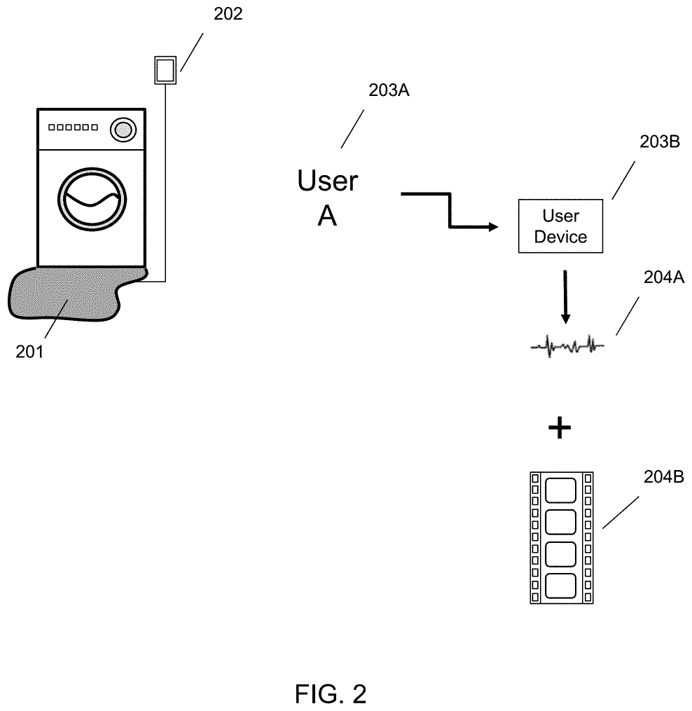

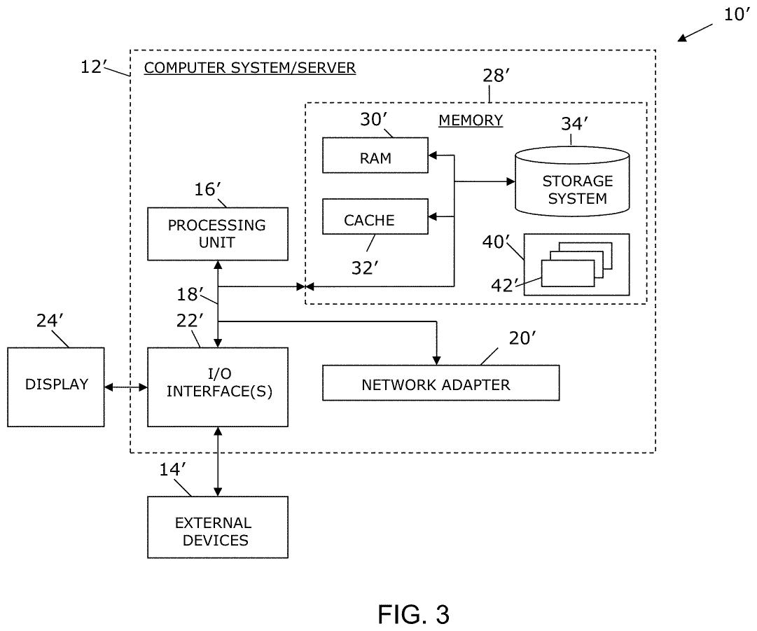

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

When small problems or issues are addressed quickly, a person can prevent severe damage to their environment. However, it is not always easy to identify small problems, for example, the problem may not have a noticeable outward manifestation. Additionally, many people are busy and do not have time to address the low severity issue. Since the person may not be aware of how severe the problem may become, the person may choose to ignore the problem in the short term and decide to address it at a later time. However, by the time the person does address the problem, the problem could be much more severe and may have caused serious damage to the user's environment and/or caused injury to the user themselves.

Traditional systems for issue notification include notifying a person or user that an issue has been detected. For example, the environment may have sensors that can detect different characteristics (e.g., water, gas, electrical shorts, etc.) that may indicate an issue. For example, a person may have a smoke detector within the environment that can detect smoke. As another example, a person may have a leak detector that can detect water or other liquid that is found in an undesirable location. These sensors may also be connected to a device or hub that can send signals or notifications to the user upon detection of the issue. For example, the sensors may send a signal to a user's mobile device that indicates an issue was found. As another example, the sensor may send the signal to a user's home device that can then send a notification to the user.

The problem with these systems is that even though the user is now aware of the issue, the user may still not address the issue. One reason for this is that the user does not think that the issue is that big of a deal and chooses not to address the issue quickly. In other words, the user has no notion of how bad or severe a small problem may become if no action is taken. Additionally, the user may think that the problem can be addressed later with no consequences to this delay in addressing the problem. No current system can provide a notification that illustrates how severe a problem can become if the user chooses not to address the issue quickly. Additionally, the current systems provide notifications when the issue is found, which may be regardless of whether the user is within physical proximity to where the issue is occurring within the environment. Thus, these notifications may not be convenient to the user, for example, the user may not be in that environment and may forget about the issue when the user returns to the environment.

Accordingly, an embodiment provides a system and method for generating and providing a notification illustrating a larger problem resulting from a smaller issue detected with one or more sensors. The system may receive information from one or more sensors that are designed to detect characteristics that may indicate an issue within an environment. Thus, the information received from the sensors indicates an issue within an environment. At the point of first detection the issue is typically a small issue or a less severe problem. The system can then identify at least one problem that is more severe than the detected issue from the information. This more severe problem may occur if the less severe problem is not addressed. To identify the more severe problem the system can access one or more secondary sources to correlate the less severe issue to the more severe problem.

Additionally from the secondary sources, the system may obtain one or more images that illustrate the more severe problem. The system can parse these images to create an aggregate image or video that illustrates the more severe problem. This aggregated image or video can then be provided to the user as a notification that illustrates the more severe problem. Thus, the system can provide a notification to the user illustrating the possible problem that can occur if the user does not address the detected issue. The notification may, in addition to the visual notification, include a non-visual notification, for example, a haptic notification, a generated odor, an audible notification, or the like. The notification may be provided when the user is detected as being in proximity to the issue.

Such a system provides a technical improvement over current issue notification systems by providing a system that generates and provides notifications that illustrate how severe a problem could become if a user does not address a smaller issue when the issue is first discovered. Thus, the user is made aware of how severe the issue may become, thereby providing the user with additional incentive to address the small issue quickly. Additionally, the system can provide the notifications when the user is within proximity to the issue, which allows the user to address the problem at that moment. Thus, the described system and methods are a more efficient and effective issue notification system than the traditional systems which are unable to provide an illustration of how severe an unaddressed problem can become or provide notifications when the user is in proximity to the problem.

FIG. 1 illustrates a method for generating and providing a notification representing a larger problem resulting from a smaller issue that is detected with one or more sensors. At 101 the system may receive information from at least one sensor in an environment. For example, a user may have sensors located within a home, workplace, retail space, or the like. These sensors may be able to detect different characteristics of the environment, for example, characteristics related to air quality, moisture level, electrical characteristics, temperature, ice formation, or the like. Example sensors may include leak detectors or moisture sensors, smoke detectors, gas detectors, carbon monoxide detectors, electrical short detectors, electrical current sensors, or the like.

After detecting a characteristic the sensor may provide information to a device. For example, the sensor may provide the information to a user device, a system hub, a cognitive intelligence system, or the like. The provided information may directly indicate an issue within the environment, for example, the sensor itself may identify the issue and then provide the issue information to the device. Additionally or alternatively, the device may process and analyze the information to identify the issue indicated by the information. To identify the issue the system may correlate the information or signal received by one or more sensors with information or signals of known issues. Once the system identifies a known issue having the same or similar information or signals, the system may then identify this known issue as the issue indicated by the information.

The system or sensor may also provide or determine information from the sensor information indicating the severity or issue level of the issue. This severity or issue level may indicate how problematic the issue is at the time of detection and may be related to how much damage or injury the issue could cause at the time of detection. For example, if the issue would not result in a lot of environmental damage at the time of detection and if addressed quickly, then the system may determine it has a low severity or low issue level. On the other hand, if the issue would result in injury or severe injury to the user even if addressed quickly, the system may determine that it has a high severity or high issue level. Thus, the issue indicated by the at least one sensor may be an issue that has a first severity, for example, a low severity, medium severity, high severity, severity identified on a scale or range, or the like.

If the system determines that the issue is of low severity, the issue may be a small one that is easily resolved or that will not cause significant damage to the environment or injury to the user if addressed quickly. For example, the sensor(s) may indicate that a small water leak has been detected under a sink. As another example, the sensor(s) may detect a small electrical short in a computer cord. These issues may be resolved before becoming larger problems, for example, an unaddressed water leak may cause structural damage, damage to environment finishes, mold growth, or the like. As another example, an unaddressed or unidentified electrical fluctuation may cause severe electrical damage to the device, electrical shock to the user, or the like.

At 102 the system may identify, using the information received at 101, a possible problem that may occur if the issue identified at 101 is not resolved in a timely manner. This possible problem may be a problem that has a greater severity or issue level than the identified issue. For example, if the small water leak is not resolved, a possible problem may be a large water puddle that can cause severe environmental damage and possible injury to a user. Thus, the large water puddle has a greater severity than the small water leak. As another example, if an odor detected from a trashcan is not resolved, a possible problem may be a stronger odor that may attract insects or rodents, thereby causing a health hazard to a user. Thus, the stronger odor has a greater severity than the small initial odor.

To identify the possible problem, the system may access one or more secondary sources, for example, the Internet, a database, crowd-sourced information, or the like. The system may access the secondary source, provide an indication of the issue to the secondary source, and then receive an indication of possible problems that are correlated or related to the issue, particularly if the issue does not get resolved quickly. The indication of the issue to the secondary source may include providing an image of the issue, providing a keyword input of the issue, or the like. To identify possible problems the system may find a correlation between the issue and a possible problem. For example, the system may search the secondary source and the secondary source can return results of the possible problems. For example, the system may provide the issue as a search query to the secondary source and receive results responsive to the search query that illustrate images of the possible problems that can occur.

The different identified problems may include both visual or visible outcomes and non-visual or user-realizable (e.g., odor, audio, haptic, etc.) outcomes. Thus, the information returned from the secondary source may include one or more images or videos, one or more other non-visual information pieces, or the like. With the one or more images or videos the system may parse the images or videos to select or otherwise obtain portions of the images or videos. The system can then aggregate or merge the portions of the images or videos into a single image or video that illustrates or represents the one or more possible problems. Additionally, the system may identify different problems that may occur based upon a passage of time. For example, the system may identify a problem that could occur if the problem is not resolved within a day and then may identify a more severe one that could occur if the problem is not resolved within a week, and the like. Thus, the system may identify possible visible and user-realizable outcomes where the severity increases with the passage of time.

From the information obtained from the one or more secondary sources, the system can determine whether the one or more possible problems can be illustrated within a notification at 103. If the one or more possible problems cannot be illustrated, the system may access the secondary source at 102 to obtain more possible problems. If, however, the one or more possible problems can be illustrated at 103, the system may provide a notification to the user that illustrates the possible problem(s) at 104. The notification may be provided on a device of the user. For example, the notification may be provided to a mobile device, wearable device, central home hub, or other information handling device of the user.

The notification may include a visual notification representing the visible outcome and a non-visual notification (e.g., audio, odor, haptic, etc.) that represents the user-realizable outcome. For example, if electrical fluctuations are detected, the system may access the system to identify that a possible problem is electrical shock. The system may then generate a video illustrating the electrical shock and also provide a haptic notification that simulates the electrical shock. Additionally, the system may correlate the level of notification to the severity of the issue. Using the electrical shock example, the system may provide a stronger haptic notification as the possible level of electrical shock increases. As another example, if an odor is detected, the system may generate a stronger odor notification that is correlated to the strength of the odor of the possible problem. Additionally, the user-realizable portion of the notification may be correlated to the identified issue. For example, if the issue is related to an odor, the non-visual notification portion may include a generated odor. As another example, if the issue is related to running water, the non-visual or user-realizable notification portion may include an audio portion that represents the sound of the running water.

Additionally, the system may provide the notification when the user is within physical proximity to where the issue is occurring within the environment. Proximity may include detecting that the user will cross the path of the issue soon. In other words, the user being within physical proximity to where the issue is occurring within the environment may include detecting that the user will be within a predetermined proximity to the issue within the environment within a predetermined time. For example, the system may monitor the path of the user and determine that the trajectory of the user will bring the user near the issue in a certain amount of time. Thus, as the user gets closer to the issue, or when the user is within a predetermined distance from or within a predetermined timeframe of encountering the issue, the system may provide the notification.

FIG. 2 illustrates an overall example of the system using an example issue of water leaking out of a washing machine. A water sensor or moisture detector 202 may detect the water leaking or the increase in moisture caused by the leaking water 201. The system may then access the secondary source(s) to identify one or more possible outcomes of the water leaking from the washing machine. In this example, a possible outcome may include a larger water puddle, damage to the structure, damage to the flooring and/or walls, injury to a user who may slip and fall in the water, and/or the like. The system may use this information related to the possible outcomes to generate a visual and non-visual notification that can be provided to the user 203A on a mobile device of the user 203B. This notification may include a visual portion, for example, a video 204B that is a merged or aggregated video or plurality of images generated from the information obtained from the one or more secondary sources. The notification may also include a non-visual portion, for example, an audio notification 204A that illustrates the sound of running water and structural damage that can be caused by the volume of leaking water increasing.

Thus, the described systems and methods represent a technical improvement over current notification systems by providing a system that can identify possible problems that may occur if an issue is not addressed quickly. These possible problems can then be used to generate and provide a notification to the user that illustrates the possible problem. Thus, the system can amplify possible issues to a more severe possible problem, which may then spur the user to address the issue more quickly. This issue amplification is not possible using conventional techniques. Additionally, the system can provide the notifications when the user is within proximity to the issue, which allows the user to become aware of the problem when the user can address the problem. This is in contrast to conventional systems which provide notifications when the issue is detected regardless of the proximity of the user to the issue. Thus, the described systems and methods provide a more efficient and effective notification system than those provided using conventional methods.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving information from at least one sensor, wherein the information indicates an issue within an environment, wherein the issue has a first severity;
identifying, using the information, at least one possible problem that (i) has a greater severity than the first severity and (ii) can occur if the issue is not resolved;
the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and
providing, to a user, a notification, wherein the notification illustrates the at least one possible problem.

2. The method of claim 1, comprising determining the severity of the issue from the information received from the at least one sensor.

3. The method of claim 1, wherein a level of the notification is correlated to the severity of the at least one possible problem.

4. The method of claim 1, wherein the notification comprises (i) a visual notification and (ii) a non-visual notification.

5. The method of claim 4, wherein the non-visual notification comprises a notification type selected from the group consisting of: audio, haptic, and odor.

6. The method of claim 1, wherein the providing comprises (i) monitoring a path of the user within the environment and (ii) determining when the user will be within physical proximity to where in the environment that the issue is occurring.

7. The method of claim 6, wherein the providing comprises providing the notification when the user is in physical proximity to where in the environment that the issue is occurring.

8. The method of claim 1, wherein the providing comprises providing the notification on a mobile device of the user.

9. The method of claim 1, wherein the at least one image comprises a plurality of image; and
comprising (i) parsing the plurality of images and (ii) merging parsed portions of the plurality of images to create a representation of the at least one problem.

10. The method of claim 1, wherein the identifying comprises using a cognitive intelligence system to identify the at least one possible problem.

11. An apparatus, comprising:
at least one processor; and
a computer readable storage medium having computer readable program code embodied therewith and executable by the at least one processor, the computer readable program code comprising:
computer readable program code configured to receive information from at least one sensor, wherein the information indicates an issue within an environment, wherein the issue has a first severity;
computer readable program code configured to identify, using the information, at least one possible problem that (i) has a greater severity than the first severity and (ii) can occur if the issue is not resolved, wherein the identifying comprises accesses a secondary source to identify the at least one possible problem;
the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and
computer readable program code configured to provide, to a user, a notification, wherein the notification illustrates the at least one possible problem.

12. A computer program product, comprising:
a computer readable storage medium having computer readable program code embodied therewith, the computer readable program code executable by a processor and comprising:
computer readable program code configured to receive information from at least one sensor, wherein the information indicates an issue within an environment, wherein the issue has a first severity;
computer readable program code configured to identify, using the information, at least one possible problem that (i) has a greater severity than the first severity and (ii) can occur if the issue is not resolved, wherein the identifying comprises accesses a secondary source to identify the at least one possible problem;
the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and
computer readable program code configured to provide, to a user, a notification, wherein the notification illustrates the at least one possible problem.

13. The computer program product of claim 12, comprising determining the severity of the issue from the information received from the at least one sensor.

14. The computer program product of claim 12, wherein a level of the notification is correlated to the severity of the at least one possible problem.

15. The computer program product of claim 12, wherein the notification comprises (i) a visual notification and (ii) a non-visual notification.

16. The computer program product of claim 12, wherein the providing comprises (i) monitoring a path of the user within the environment and (ii) determining when the user will be within physical proximity to where in the environment that the issue is occurring, and (iii) providing the notification when the user is in physical proximity to where in the environment the issue is occurring.

17. The computer program product of claim 12, wherein the providing comprises providing the notification on a mobile device of the user.

18. The computer program product of claim 12, wherein the at least one image comprises a plurality of images; and
comprising (i) parsing the plurality of images and (ii) merging parsed portions of the plurality of images to create a representation of the at least one problem.

19. The computer program product of claim 12, wherein the identifying comprises using a cognitive intelligence system to identify the at least one possible problem.

20. A method, comprising:
receiving information from at least one sensor that indicates a problem within an environment of a user, wherein the problem comprises a problem having a first issue level;
identifying a possible problem if the problem is not addressed, wherein the possible problem comprises an amplified version of the problem having a higher issue level than the first issue level;
the identifying comprising (i) searching a secondary source using the issue as a search query and (ii) receiving, responsive to the searching, results from the secondary source comprising the at least one problem resulting from the issue, wherein the results comprise at least one image illustrating the at least one problem; and
providing, responsive to detecting the user is in proximity to the amplified problem, a notification to the user, wherein the notification comprises (i) a visual notification generated from the at least one image and (ii) a non-visual notification.
